(19) United States
(12) Patent Application Publication
(10) Pub. No.: US 2009/0081132 A1
(43) Pub. Date: Mar. 26, 2009

(54) Water-borne aerosol composition

(75) Inventor: Masahiro Yamada, Toyonaka (JP)

Correspondence Address: BIRCH STEWART KOLASCH & BIRCH, PO BOX 747, FALLS CHURCH, VA, 22040-0747, US

(73) Assignee: SUMITOMO CHEMICAL COMPANY, LIMITED

(21) Appl. No.: 12/232,561

(22) Filed: Sep. 19, 2008

(30) Foreign Application Priority Data
Sep. 20, 2007 (JP) 2007-243178

(51) Int. Cl. A01N 25/06; A01P 7/04

(52) U.S. Cl. 424/45

(57) ABSTRACT

A water-borne aerosol composition containing an oil soluble insecticidal component (A), a hydrophobic organic solvent (B), water (C), a non-ionic surfactant (D) and a propellant (E), wherein the oil soluble component (A) is 4-methoxymethyl-2,3,5,6-tetrafluorobenzyl 3-(2-cyano-1-propenyl)-2,2-dimethylcyclopropanecarboxylate and wherein the non-ionic surfactant (D) has a HLB in the range of 4.1 to 7.0, shows an excellent insecticidal activity and is useful.

### FIELD OF THE INVENTION

The present invention relates to a water-borne aerosol composition comprising an insecticidal component.

### DESCRIPTION OF THE RELATED ART

Water-borne insecticidal compositions for spraying which are formulated with water and water-borne aerosol compositions have been proposed from a viewpoint of reducing a risk of fire by the conventional insecticidal compositions and the like, and various products have already been commercially available.

JP 2004-2363 A discloses 4-methoxymethyl-2,3,5,6-tetrafluorobenzyl 3-(2-cyano-1-propenyl)-2,2-dimethylcyclopropanecarboxylate (also referred to as “present compound” hereinafter) as an insecticidal component, as well as a water-borne aerosol composition containing the present compound (Formulation Example 9 of JP 2004-2363 A).

### DISCLOSURE OF THE INVENTION

### Problem to be Solved by the Invention

An object of the present invention is to enhance the insecticidal effect of the present compound in a water-borne aerosol composition containing the present compound as the insecticidal component.

### Means for Solving the Problem

The present inventors have earnestly investigated the object described above and found that the use of a non-ionic surfactant having a particular hydrophile-lipophile balance (HLB) in combination with the present compound as an insecticidal component allows the present compound to show a sufficient insecticidal effect. They completed the present invention based on the surprising finding.

That is, a water-borne aerosol composition of the present invention is a composition comprising:
(A) an oil soluble insecticidal component,
(B) a hydrophobic organic solvent,
(C) water,
(D) a non-ionic surfactant, and
(E) a propellant;
   wherein the oil soluble insecticidal component (A) is 4-methoxymethyl-2,3,5,6-tetrafluorobenzyl 3-(2-cyano-1-propenyl)-2,2-dimethylcyclopropanecarboxylate, and wherein the non-ionic surfactant (D) has a HLB ranging from 4.1 to 7.0.

In the present specification, the HLB of the non-ionic surfactant refers to the hydrophile-lipophile balance, which, in the present invention, is calculated by the Griffin method. However, when it cannot be directly calculated by the Griffin method, values calculated by the Devies method, Oda method which applies the organic conceptual diagram, etc., may be used with an appropriate conversion to the values obtained by the Griffin method. When two or more kinds of surfactants are used, their HLB is also calculated according to the following equation:

HLB=ΣHiwi/Σwi (1)

where Hi indicates HLB of non-ionic surfactant i and wi indicates weight of non-ionic surfactant i.

The content of component (A) is preferably in the range of 0.001 to 5% by weight relative to the total composition. The content of component (D) is preferably in the range of 0.1 to 5% by weight relative to the total composition.

The weight ratio of component (B) to component (C) is preferably in the range of 1:27 to 5:1.

The content of component (E) is preferably in the range of 10 to 80% by weight relative to the total composition.

As component (B), a hydrophobic organic solvent having a boiling point of 150° C. or higher is preferred, and a saturated hydrocarbon solvent is further preferred.

### ADVANTAGE OF THE INVENTION

The water-borne aerosol composition of the present invention uses the non-ionic surfactant having a particular HLB in combination with the present compound as an insecticidal component, thus yielding an excellent insecticidal effect.

### DESCRIPTION OF PREFERRED EMBODIMENTS

The water-borne aerosol composition according to the present invention is described in more detail in the following, but the present invention is not limited by such embodiments in any way.

The content of the oil soluble insecticidal component (A) used in the present invention is preferably in the range of 0.001 to 5% by weight, more preferably in the range of 0.005 to 3% by weight, relative to the total composition.

The hydrophobic organic solvent (B) used in the present invention is a hydrophobic organic solvent, which has a solubility of 5 g or less in 100 g of water at 20° C. and is a liquid at ambient temperature, preferably has a boiling point of 150° C. or higher under atmospheric pressure. Specifically, aliphatic organic solvents with 8 or more carbon atoms, alicyclic organic solvents with 8 or more carbon atoms or aliphatic ester solvents with 8 or more carbon atoms are preferred. Saturated hydrocarbon solvents with 8 or more carbon atoms are further preferred. Examples of the saturated hydrocarbon solvents with 8 or more carbon atoms include nonane, decane, undecane, dodecane, tridecane, tetradecane, pentadecane, 2-methyldecane and the like. Examples from commercial products include saturated hydrocarbon solvents such as Neochiozol (manufactured by Chuokasei Co., Ltd.), Norpar 12, Norpar 13, Norpar 15 (manufactured by Exxon Mobil Corp.) and the like; Isopar E, Isopar G, Isopar H, Isopar M, Isopar V, Exxsol D40, Exxsol D60, Exxsol D80 (manufactured by Exxon Mobile Corp.), IP-2028 (manufactured by Idemitsu Petrochemical Co., Ltd.), kerosene and the like. Examples of the ester solvents include isopropyl palmitate, isopropyl myristate, hexyl laurate, diisopropyl adipate, dihexyl adipate, diethyl sebacate, dibutyl sebacate, triethyl acetylcitrate, tributyl acetylcitrate and the like.

The content of the hydrophobic organic solvent is preferably in the range of 3 to 50% by weight, more preferably in the range of 5 to 20% by weight relative to the total composition.

Water (C) used in the present invention is not particularly limited so far as it is water used as industrial water, but ion-exchange water is preferably used. The content of water is preferably in the range of 10 to 80% by weight, more preferably in the range of 20 to 70% by weight relative to the total composition.

The weight ratio of the hydrophobic organic solvent (B) to water (C) contained in the water-borne aerosol composition of the present invention is preferably in the range of 1:27 to 5:1.

The non-ionic surfactant (D) used in the present invention has a HLB in the range of 4.1 to 7.0, preferably in the range of 4.3 to 7.0. Examples of such a non-ionic surfactant include sorbitan fatty acid esters, polyoxyethylene sorbitan fatty acid esters, glycerin fatty acid esters, polyoxyalkyl ethers, polyoxyethylene alkylphenyl ethers, alkyl glycoxides, polyoxyethylene fatty acid esters, sucrose fatty acid esters, fatty acid alkanolamides and the like. The non-ionic surfactant (D) can be used alone or in admixture. When two or more of the surfactants are used, the weight averaged HLB of the surfactants mixed has to be adjusted to the range of 4.1 to 7.0 as described above.

The content of the non-ionic surfactant is preferably in the range of 0.1 to 5% by weight, more preferably in the range of 0.3 to 3% by weight, relative to the total composition, in view of the balance between the contents of the non-ionic surfactant and the oil soluble insecticidal component described above.

Examples of the propellant (E) used in the present invention includes, liquefied petroleum gas (LPG), dimethyl ether, propane, n-butane, isobutane and the like. The propellant (E) can be used alone or in admixture of two or more. Liquefied petroleum gas (LPG) is preferably used. In the present invention, nitrogen gas or compressed air may be added as needed. The content of the propellant is preferably in the range of 10 to 80% by weight, more preferably in the range of 20 to 70% by weight, relative to the total composition.

The propellant can be filled together with other components in a pressure-resistant container. Alternatively, it can be filled separately from other components in a peripheral space of a pressure-resistant container having a double-walled structure. Use of the latter structure can prevent the propelling pressure from falling during a course of usage.

The water-borne aerosol composition of the present invention may contain one or more active insecticidal components other than the present compound, synergists for the active insecticidal components, perfumes, anticorrosion agents, fungicides, antioxidants, pH regulators and the like in addition to components (A) to (E) described above as needed as far as their incorporation does not adversely affect the advantage of the present invention. The total content of these additives is 5% by weight or less relative to the total composition.

Other active insecticidal components include, for example, Etofenprox, Fenvalerate, Esfenvalerate, Fenpropathrin, Cypermethrin, Permethrin, Cyhalthrin, Deltamethrin, Cycloprothrin, Fluvalinate, Bifenthrin, 2-methyl-2-(4-bromodifluoromethoxyphenyl)propyl (3-phenoxybenzyl)ether, Tralomethrin, Silafluofen, d-Phenothrin, Cyphenothrin, d-Resmethrin, Acrinathrin, Cyfluthrin, Tefluthrin, Transfluthrin, Tetramethrin, Allethrin, d-Furamethrin, Prallethrin, Empenthrin, 5-(2-propynyl)furfuryl 2,2,3,3-tetramethylcyclopropanecarboxylate and the like.

The synergists for the active insecticidal component include, for example, bis(2,3,3,3-tetrachloropropyl)ether (S-421), N-(2-ethylhexyl)bicyclo[2.2.1]hept-5-ene-2,3-dicarboximide (MGK-264), α-[2-(2-butoxyethoxy)ethoxy]-4,5-methylenedioxy-2-propyltoluene[piperonyl butoxide] and the like.

Various natural and artificial perfumes can be used as the perfume. For example, natural perfumes originated from animals or plants or artificial perfumes such as hydrocarbons, alcohols, phenols, aldehydes, ketones, lactones, oxides, esters and the like can be used.

The anticorrosion agents include benzotriazole, dicylohexylamine nitrite, tolyltriazole and the like.

The fungicides include o-phenylphenol, isopropylmethylphenol, 2-chloro-4-phenylphenol, thymol and the like.

The antioxidants include, for example, 2′-methylenebis(6-t-butyl-4-ethylphenol), 2,6-di-t-butyl-4-methylphenol (BHT), 2,6-di-t-butylphenol, 2,2′-methylenebis(6-t-butyl-4-methylphenol), 4,4′-methylenebis(2,6-di-t-butylphenol), 4,4′-butylidenebis(6-t-butyl-3-methylphenol), 4,4′-thiobis(6-t-butyl-3-methylphenol), dibutylhydroquinone (DBH) and the like.

The pH regulators include ammonia, monoethanolamine, diethanolamine, triethanolamine, sodium carbonate and the like.

The water-borne aerosol composition of the present invention can be manufactured by a conventional method. For example, components (A) to (E) and other components described above as needed may be mixed to fill a pressure-resistant container for aerosol. A cylindrical container with a base manufactured from a metal such as aluminum, tin and the like, a synthetic resin such as polyethylene terephthalate and the like, heat-resistant glass and the like can be used as the pressure-resistant container.

The water-borne aerosol composition of the present invention is applied by spraying an insecticidally effective amount of it directly onto harmful insects, the migration route thereof and/or the locus where they inhabit. The applied amount is generally 0.1 to 500 mg of the present compound per square meter of applied area when applied over an area, and is generally 1 to 1000 mg per square meter of applied space when applied to a space.

Harmful insects, to which the water-borne aerosol composition of the present invention is effective include, for example, arthropods such as insects, mites and the like and specifically include, for example, the insects and the like in the following.

Lepidoptera

Pyralidae such as Chilo suppressalis, Cnaphalocrocis medinalis, Plodia interpunctella and the like, Noctuidae such as Spodoptera litura, Pseudaletia separata, Mamestra brassicae and the like, Pieridae such as Pieris rapae crucivora and the like, Tortricidae such as Adoxophyes orana and the like, Carposinidae, Lyonetiidae, Lymantriidae, Antographa, Agrotis spp. such as Agrotis segetum, Agrotis ipsilon and the like, Helicoverpa spp., Haliothis spp., Plutella xylostella, Parnara guttata guttata, Tinea pellionella, Tineola bisselliella and the like.

Diptera

Culex such as Culex pipiens pallens, Culex tritaeniorhynchus and the like, Aedes such as Aedes aegypti, Aedes albopictus and the like, Anophelinae such as Anopheles sinensis and the like, Chironomidae, Muscidae such as Musca domestica, Muscina stabulans, Fannia canicularis and the like, Calliphoridae, Sarcophagidae, Anthomyiidae such as Delia platura, Delia antiqua and the like, Tephritidae, Agromyzidae, Drosophilidae, Psychodidae, Phoridae, Tabanidae, Simuliidae, Culicoides, Ceratopogonidae and the like.

Blattaria

Blattella germanica, Periplaneta fuliginosa, Periplaneta americana, Periplaneta burnnea, Lobopterella dimidiatipes and the like.

Hymenoptera

Formicidae, Vespidae, Bethylidae, Tenthredinidae such as Athalia rosae ruficornis and the like.

Siphonaptera

Ctenocephalides canis, Ctenocephalides felis felis, Putlex irritans and the like.

Anoplura

Pediculus humanus, Pthirus pubis, Pediculus humanus humanus, Pediculus capitis and the like.

Isoptera

Reticulitermes speratus speratus, Coptotermes formosanus and the like.

Hemiptera

Delphacidae such as Laodelphax stratella, Nilaparvata lugens, Sogatella furcifera and the like, Deltocephalidae such as Nephotettix cincticeps, Nephotettix virescens and the like, Aphididae, Pentatomidae, Aleyrodidae, Coccoidae, Cimicidae such as Cimex lectularius and the like, Tingidae, Psyllidae and the like.

Coleoptera

Attagenus japonicus, Anthrenus verbasci, corn rootworms such as Western corn rootworm, Southern corn rootworm and the like, Scarabaeidae such as Anomala cuprea, Anomala rufocuprea and the like, Curculionidae such as Sitophilus zeamais, Lissorhoptrus oryzophilus, Anthonomus grandis grandis, Callosobruchus chinensis and the like, Tenebrionidae such as Tenebrio molitor, Tribolium castaneum and the like, Chrysomelidae such as Oulema oryzae, Phyllotreta striolata, Aulacophora femoralis and the like, Anobiidae, Epilachna spp. such as Epilachna vigintioctopunctata and the like, Lyctidae, Bostrychidae, Cerambycidae, Paederus fuscipes and the like.

Thysanoptera

Thrips palmi, Frankliniella occidentalis, Thrips hawaiiensis and the like.

Orthoptera

Gryllotalpidae, Acrididae and the like.

Acarines

Pyroglyphidae such as Dermatophagoides farinae, Dermatophagoides pteronyssinus and the like, Acaridae such as Tyrophagus putrescentiae, Aleuroglyphus ovatus and the like, Glycyphagidae such as Glycyphagidae privatus, Glycyphagidae domesticus, Glycyphagus destructor and the like, Cheyletidae such as Cheyletus malaccensis, Cheyletus fortis and the like, Tarsonemidae, Chortoglyphidae, Haplochthoniidae, Tetranychidae such as Tetranychus urticae, Tetranychus Kanzawai, Panonychus citri, Panonychus ulmi and the like, Ixodidae such as Haemaphysalis longicornis and the like, Demanyssidae such as Ornithonyssus sylviarum, Dermanyssus gallinae and the like.

### EXAMPLES

The present invention is described in more detail below with reference to Examples, but not limited by such Examples in any way.

### Production Example 1

0.02 part by weight of 4-methoxymethyl-2,3,5,6-tetrafluorobenzyl 1R-trans-3-(2-cyano-1-propenyl (E/Z=1/9))-2,2-dimethylcyclopropanecarboxylate, 8.98 parts by weight of an isoparaffinic hydrocarbon solvent (Isopar M, manufactured by Exxon Mobil Corp.) as the hydrocarbon organic solvent and 1 part by weight of sorbitan monooleate (Leodol SP-O10, manufactured by Kao Corp., HLB=4.3) as the non-ionic surfactant were mixed and dissolved, and then filled together with 50 parts by weight of water in a pressure-resistant container, to which an aerosol valve was attached. The pressure-resistant container was then filled with 40 parts by weight of liquefied petroleum gas as a propellant through the aerosol valve to yield a water-borne aerosol composition according to the present invention.

### Production Example 2

0.02 part by weight of 4-methoxymethyl-2,3,5,6-tetrafluorobenzyl 1R-trans-3-(2-cyano-1-propenyl(E/Z=1/9))-2,2-dimethylcyclopropanecarboxylate, 8.98 parts by weight of an isoparaffinic hydrocarbon solvent (Isopar M, manufactured by Exxon Mobil Corp.) and 1 part by weight of a mixture of glyceryl monooleate (Leodol MO-60, manufactured by Kao Corp., HLB=2.8) and polyoxyethylene (n=20) sorbitan monooleate (Leodol TW-O120, manufactured by Kao Corp., HLB=15.0) as the non-ionic surfactant were used to yield a water-borne aerosol composition according to the present invention in the same manner as in Production Example 1. The mixing ratio of the glyceryl monooleate and the polyoxyethylene (n=20) sorbitan monooleate was 8:2 and HLB of the mixture was 5.24 calculated from the above equation (1).

### Production Example 3

0.02 part by weight of 4-methoxymethyl-2,3,5,6-tetrafluorobenzyl 1R-trans-3-(2-cyano-1-propenyl(E/Z=1/9))-2,2-dimethylcyclopropanecarboxylate, 8.98 parts by weight of an isoparaffinic hydrocarbon solvent (Isopar M, manufactured by Exxon Mobil Corp.) and 1 part by weight of a mixture of sorbitan monooleate (Leodol SP-O10, manufactured by Kao Corp., HLB=4.3) and polyoxyethylene (n=20) sorbitan monooleate (Leodol TW-O120, manufactured by Kao Corp., HLB=15.0) as the non-ionic surfactant were used to yield a water-borne aerosol composition according to the present invention in the same manner as in Production Example 1. The mixing ratio of the sorbitan monooleate and the polyoxyethylene (n=20) sorbitan monooleate was 8.4:1.6 and HLB of the mixture was 6.01 calculated from the above equation (1).

### Production Example 4

0.02 part by weight of 4-methoxymethyl-2,3,5,6-tetrafluorobenzyl 1R-trans-3-(2-cyano-1-propenyl(E/Z=1/9))-2,2-dimethylcyclopropanecarboxylate, 8.98 parts by weight of an isoparaffinic hydrocarbon solvent (Isopar M, manufactured by Exxon Mobil Corp.) and 1 part by weight of a mixture of sorbitan monooleate (Leodol SP-O10, manufactured by Kao Corp., HLB=4.3) and sorbitan monolaurate (Leodol SP-L10, manufactured by Kao Corp., HLB=8.6) as the non-ionic surfactant were used to yield a water-borne aerosol composition according to the present invention in the same manner as in Production Example 1. The mixing ratio of the sorbitan monooleate and the sorbitan monolaurate was 3.8:6.2 and HLB of the mixture was 6.97 calculated from the above equation (1).

### Reference Production Example 1

0.02 part by weight of 4-methoxymethyl-2,3,5,6-tetrafluorobenzyl 1R-trans-3-(2-cyano-1-propenyl(E/Z=1/9))-2,2-dimethylcyclopropanecarboxylate, 8.98 parts by weight of an isoparaffinic hydrocarbon solvent (Isopar M, manufactured by Exxon Mobil Corp.) and 1 part by weight of sorbitan monolaurate (Leodol SP-L10, manufactured by Kao Corp., HLB=8.6) as the non-ionic surfactant were used to yield a water-borne aerosol composition in the same manner as in Production Example 1.

### Reference Production Example 2

0.02 part by weight of 4-methoxymethyl-2,3,5,6-tetrafluorobenzyl 1R-trans-3-(2-cyano-1-propenyl(E/Z=1/9))-2,2-dimethylcyclopropanecarboxylate), 8.98 parts by weight of an isoparaffinic hydrocarbon solvent (Isopar M, manufactured by Exxon Mobil Corp.) and 1 part by weight of glyceryl monolaurate (Leodol MO-60, manufactured by Kao Corp., HLB=2.8) as the non-ionic surfactant were used to yield a water-borne aerosol composition according to the present invention in the same manner as in Production Example 1.

### Text Example 1

Ten adult houseflies (five each for males and females) were placed in a first polyethylene cup (diameter of lower part: 10.6 cm, diameter of upper part: 12.0 cm and height: 7 cm) and an opening of the top of the cup was covered with a 16-mesh nylon gauze. The first cup was placed at the bottom center of a cubic chamber with a side length of 70 cm and provided with a small window at the center of one lateral side. In addition, a second cup with a similar shape to the cup described above but not containing houseflies was placed at the distant side of the first cup viewed from the small window. Each of the water-borne aerosol compositions prepared as described above was sprayed in an amount of 300 mg through the small window of the chamber to evaluate the knockdown rate in 7 minutes after spraying. The results are shown in Table 1.

Each test was repeated twice and its average value is given as the results.

TABLE 1

| Aerosol composition under test | Knockdown rate (%) |
|---|---|
| Production Example 1 | 95 |
| Production Example 2 | 90 |
| Production Example 3 | 90 |
| Production Example 4 | 90 |
| Reference Production Example 1 | 70 |
| Reference Production Example 2 | 55 |

As found in Table 1, the water-borne aerosol compositions in Production Examples 1 to 4 according to the present invention show a high knockdown rate of 95 and 90% in 7 minutes after spraying.

### Production Example 5

0.2 part by weight of 4-methoxymethyl-2,3,5,6-tetrafluorobenzyl 1R-trans-3-(2-cyano-1-propenyl (E/Z=1/9))-2,2-dimethylcyclopropanecarboxylate, 5.8 parts by weight of a normal paraffinic hydrocarbon solvent (Neochiozol, manufactured by Chuokasei Co., Ltd.) and 3 parts of isopropyl myristate as the hydrophobic organic solvent and 1 part by weight of sorbitan monooleate (Leodol SP-O10, manufactured by Kao Corp., HLB=4.3) as the non-ionic surfactant were mixed and dissolved, and then filled together with 40 parts by weight of water in a pressure-resistant container, to which an aerosol valve was attached. The pressure-resistant container was then filled with 50 parts by weight of a 1:1 mixture of dimethyl ether and liquefied petroleum gas as a propellant through the aerosol valve to yield a water-borne aerosol composition according to the present invention.

### Reference Production Example 3

0.2 part by weight of 4-methoxymethyl-2,3,5,6-tetrafluorobenzyl 1R-trans-3-(2-cyano-1-propenyl(E/Z=1/9) )-2,2-dimethylcyclopropanecarboxylate), 5.8 parts by weight of a normal paraffinic hydrocarbon solvent (Neochiozol manufactured by Chuokasei Co., Ltd.) and 3 parts of isopropyl myristate and 1 part by weight of glyceryl monooleate (Leodol MO-60, manufactured by Kao Corp., HLB=2.8) as the non-ionic surfactant were used to yield a water-borne aerosol composition according to the present invention in the same manner as in Production Example 5.

### Test Example 2

An adult female hornet (Vespa mandarinia japonica) was placed in a cubic stainless cage (25 cm×25 cm×25 cm, 16 mesh). The cage was hung in a test chamber (1.8 m×1.8 m×1.8 m) so that the center of the cage was at a height of 1.2 m.

Each of the water-borne aerosol compositions prepared as described above was sprayed in an amount of 8 g from the point at the sideward distance of 100 cm. The hornet was transferred from the cage to a clean polyethylene cup (10.6 cm in bottom diameter, 12 cm in top diameter, 7 cm in height), containing cotton impregnated with a honey solution, 3 minutes after. After one day, the mortality was observed. The test was repeated five times for Production Example 3 and four times for Reference Production Example 3. The results are shown in Table 2.

TABLE 2

| Aerosol composition under test | Knockdown rate (%) |
|---|---|
| Production Example 5 | 100 |
| Reference Production Example 3 | 50 |

### INDUSTRIAL APPLICABILITY

The water-borne aerosol composition according to the present invention provides an excellent insecticidal effect and is useful.

1. A water-borne aerosol composition comprising:
(A) an oil soluble insecticidal component,
(B) a hydrophobic organic solvent,
(C) water,
(D) a non-ionic surfactant, and
(E) a propellant;
wherein the oil soluble insecticidal component (A) is 4-methoxymethyl-2,3,5,6-tetrafluorobenzyl 3-(2-cyano-1-propenyl)-2,2-dimethylcyclopropanecarboxylate, and wherein the non-ionic surfactant (D) has a hydrophile-lipophile balance (HLB) ranging from 4.1 to 7.0.

2. The water-borne aerosol composition according to claim 1, wherein the content of component (A) is in the range of 0.001 to 5% by weight relative to the total composition and the content of component (D) is in the range of 0.1 to 5% by weight relative to the total composition.

3. The water-borne aerosol composition according to claim 1 or 2, wherein the weight ratio of component (B) to component (C) is in the range of 1:27 to 5:1.

4. The water-borne aerosol composition according to claim 1, wherein the content of component (E) is in the range of 10 to 80% by weight relative to the total composition.

5. The water-borne aerosol composition according to claim 1, wherein component (B) is a hydrophobic organic solvent with a boiling point of 150° C. or above.

6. The water-borne aerosol composition according to claim 5, wherein component (B) is a saturated hydrocarbon solvent.
